(19) United States
(12) Patent Application Publication
(10) Pub. No.: US 2011/0133569 A1
(43) Pub. Date: Jun. 9, 2011

(54) WIRELESS POWER TRANSMISSION DEVICE AND WIRELESS POWER RECEPTION DEVICE

(75) Inventors: Sang Hoon CHEON, Daejeon (KR); Yong Hae KIM, Daejeon (KR); Seung Youl KANG, Daejeon (KR); Myung Lae LEE, Daejeon (KR); Jong Moo LEE, Daejeon (KR); Tae Hyoung ZYUNG, Daejeon (KR)

(73) Assignee: Electronics and Telecommunications Research Institute, Daejeon (KR)

(21) Appl. No.: 12/779,241

(22) Filed: May 13, 2010

(30) Foreign Application Priority Data
Dec. 4, 2009 (KR) 10-2009-0119682

(51) Int. Cl. H02J 17/00

(52) U.S. Cl. 307/104

(57) ABSTRACT

Provided are a wireless power transmission device and wireless power reception device. A power-relaying resonant coil is disposed between a power transmitter and a power receiver to increase transmission efficiency and lengthen a transmission distance. The wireless power transmission device includes a power generation module for generating power, a power coil for receiving the power, a transmitting coil for resonating at the unique resonant frequency due to magnetic induction with the power coil and generating a non-radiative electromagnetic wave, and one or more power relay coils for relaying the non-radiative electromagnetic wave.

### CROSS-REFERENCE TO RELATED APPLICATION

This application claims priority to and the benefit of Korean Patent Application No. 10-2009-0119682, filed Dec. 4, 2009, the disclosure of which is incorporated herein by reference in its entirety.

### BACKGROUND

1. Field of the Invention

The present invention relates to a wireless power transmission system, and more particularly to a wireless power transmission device that lengthens a wireless power transmission distance and enables power transmission to several devices.

2. Discussion of Related Art

Recent electronic products including home appliances are rapidly being miniaturized and made portable. Also, as information and signals are wirelessly transferred, lines connected with devices are disappearing. For home appliances, attempts to wirelessly transmit power to them are ongoing. Electromagnetic induction is most frequently used to wirelessly transmit power. To be specific, wireless power transmission based on electromagnetic induction is used in electric toothbrushes, etc. However, transmission efficiency greatly deteriorates when a distance increases only slightly, and an eddy current may cause unnecessary and dangerous heat.

A magnetic resonance-based wireless power transmission method, which is a non-radiative energy transfer technique currently being researched, can have high transmission efficiency even at a distance of several meters greater than the transmission distance of a conventional electromagnetic induction method. This technique is based on evanescent wave coupling in which electromagnetic waves are transmitted from one medium to another through a near electromagnetic field when the two mediums resonate at the same frequency. Thus, only when two mediums have the same resonant frequency, is energy transferred, and non-used energy is reabsorbed by the electromagnetic field. For this reason, the electromagnetic waves are not harmful to adjacent machines or human bodies unlike other electromagnetic waves.

In each of a transmitter and receiver of a magnetic resonance-based wireless power transmission system, one resonator that resonates at a transmission frequency is included. When resonant frequencies of the two resonators are exactly the same, high-efficiency transmission is enabled. Since the resonant frequencies of the two resonators are slightly different in an actual system, a variable capacitor capable of adjusting a resonant frequency is included in the transmitter or receiver to adjust one of the resonant frequencies. Here, huge voltage is generated at the both ends of a coil, and thus the capacitor should have a huge breakdown voltage. Also, since impedance matching between the transmitter and the receiver is indispensable at a transmission frequency, a distance between a transmitting coil and a power coil and a distance between a receiving coil and a load coil should be appropriately adjusted according to a transmission distance.

Furthermore, it is complicated to transmit power to several devices. In general, when distances between a power transmitter and devices are different and the number of the devices are changed, impedance matching is broken, and power transmission is not performed.

### SUMMARY OF THE INVENTION

The present invention is directed to a wireless power transmission system for wirelessly transmitting power to a plurality of electronic devices over a long distance.

One aspect of the present invention provides a wireless power transmission device including: one or more power relay coils disposed between a transmitting coil that resonates at a unique resonant frequency due to magnetic induction and generates a non-radiative electromagnetic wave and a receiving coil that receives the non-radiative electromagnetic wave and resonates at the same frequency as the transmitting coil, and relaying the non-radiative electromagnetic wave.

The power relay coils may resonate at the same frequency as the transmitting coil. Each of the power relay coils may include a resonant frequency adjusting means for adjusting the unique resonant frequency of the power relay coil. The resonant frequency adjusting means may include a variable capacitor. As the number of the power relay coils increases, a power transmission distance may increase. The power relay coils may be disposed at apexes or edges of a polygon and relay the non-radiative electromagnetic wave inside the polygon. The power relay coils may be disposed around a circle and relay the non-radiative electromagnetic wave inside the circle.

Another aspect of the present invention provides a wireless power transmission device including: a power generation module for generating power; a power coil for receiving the power; a transmitting coil for resonating at a unique resonant frequency due to magnetic induction with the power coil, generating a non-radiative electromagnetic wave, and transmitting the power to respective receiving coils of one or more power receivers; and a control means for detecting the power receivers and transmitting a signal indicating which one of the power receivers receives the power at a specific time in a time division method to the power receivers. The control means may include: a device detection means for detecting the power receivers and counting the number of the power receivers; a processing means for determining time periods for which the respective power receivers receive the power in the time division method according to the number of the power receivers; and a signal transmission means for transmitting the signal indicating which one of the power receivers receives the power at a specific time to the power receivers.

The transmitting coil may include a resonant frequency adjusting means for adjusting the unique resonant frequency of the transmitting coil. The resonant frequency adjusting means may include a variable capacitor.

Yet another aspect of the present invention provides a wireless power reception device including: a receiving coil for receiving a non-radiative electromagnetic wave generated by a transmitting coil of a power transmitter and resonating at the same frequency as the transmitting coil; a load coil for receiving energy stored in the receiving coil; and a power receiving module for receiving power received by the receiving coil. Here, the receiving coil includes a resonant frequency adjusting means for adjusting a unique frequency of the receiving coil to receive the non-radiative electromagnetic wave and resonate during a divided time period only.

The resonant frequency adjusting means may include a capacitor and a switch, and adjust the switch to equalize the unique resonant frequency of the receiving coil with a unique resonant frequency of the transmitting coil during the divided time period only. The resonant frequency adjusting means may include a control means for receiving a signal having information on a time period for which the power is received from the power transmitter in a time division method, and controlling the switch according to the signal. The resonant frequency adjusting means may include a variable capacitor, and adjust the capacitance of the variable capacitor to equalize the unique resonant frequency of the receiving coil with a unique resonant frequency of the transmitting coil during the divided time period only.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a diagram illustrating the basic concept of a wireless power transmission system;

FIGS. 2A and 2B are diagrams of power transmission systems including a power relay coil according to exemplary embodiments of the present invention;

FIG. 3 is a graph showing power transmission efficiency increased using a power relay coil according to an exemplary embodiment of the present invention;

FIGS. 4A and 4B are diagrams illustrating the concept of wireless power transmission systems according to exemplary embodiments of the present invention that separately transmit power to several devices according to time;

FIG. 5 is a diagram of a power transmission system according to an exemplary embodiment of the present invention that separately transmits power to several devices according to time and increases power transmission efficiency using a power relay coil; and

FIG. 6 is a diagram of a power transmission system according to an exemplary embodiment of the present invention that separately transmits power to several devices according to time and forms a space in which power transmission can be efficiently performed using a power relay coil.

### DETAILED DESCRIPTION OF EXEMPLARY EMBODIMENTS

Hereinafter, exemplary embodiments of the present invention will be described in detail. However, the present invention is not limited to the embodiments disclosed below but can be implemented in various forms. The following embodiments are described in order to enable those of ordinary skill in the art to embody and practice the present invention. To clearly describe the present invention, parts not relating to the description are omitted from the drawings. Like numerals refer to like elements throughout the description of the drawings.

Throughout this specification, when an element is referred to as being “connected” or “coupled” to another element, it can be directly connected or coupled to the other element or electrically connected or coupled to the other element with yet another element interposed between them.

Throughout this specification, when an element is referred to as “comprises,” “includes,” or “has” a component, it does not preclude another component but may further include the other component unless the context clearly indicates otherwise. Also, as used herein, the terms “ . . . unit,” “ . . . device,” “ . . . module,” etc., denote a unit of processing at least one function or operation, and may be implemented as hardware, software, or combination of hardware and software.

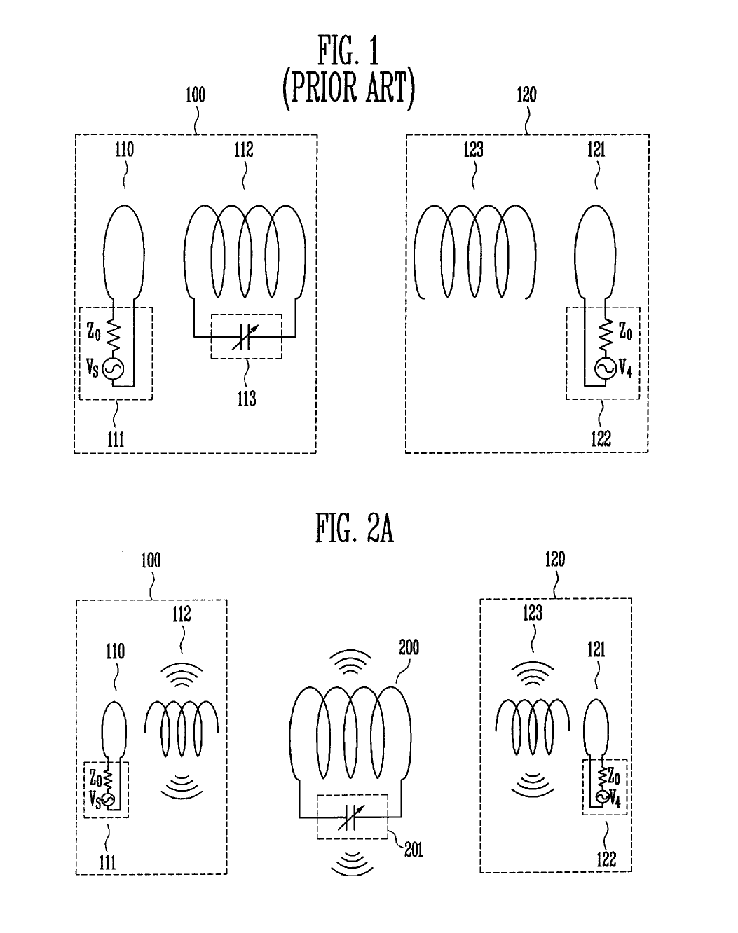

FIG. 1 is a diagram illustrating the basic structure of a wireless power transmission system. Referring to FIG. 1, a wireless power transmission system includes a power transmitter 100 having a power generation module 111 that generates power, a power coil 110 to which the generated power is applied, a transmitting coil 112 that resonates at the unique resonant frequency due to magnetic induction with the power coil 110 and generates a non-radiative electromagnetic wave, and a variable capacitor 113 that adjusts a resonant frequency of the transmitting coil 112. Also, the wireless power transmission system includes a power receiver 120 having a receiving coil 123 that receives the generated non-radiative electromagnetic wave and resonates at the same frequency as the transmitting coil 112, a load coil 121 that receives energy stored in the receiving coil 123, and a power receiving module 122 that receives power received by the load coil 121.

In the system, a wireless power transmission distance corresponds to a distance between the transmitting coil 112 and the receiving coil 123. A distance between the power coil 110 and the transmitting coil 112 and a distance between the receiving coil 123 and the load coil 121 have optimum values according to the transmission distance. In general, the distances are not great and do not have a considerable effect on the sizes of a transmission module and reception module. In comparison with other conventional methods, a magnetic resonance-based wireless power transmission method shows high efficiency even at a distance of several meters. However, with an increase in transmission distance, the transmission efficiency of the magnetic resonance-based wireless power transmission method rapidly deteriorates. A method for solving this problem will be described according to exemplary embodiments of the present invention.

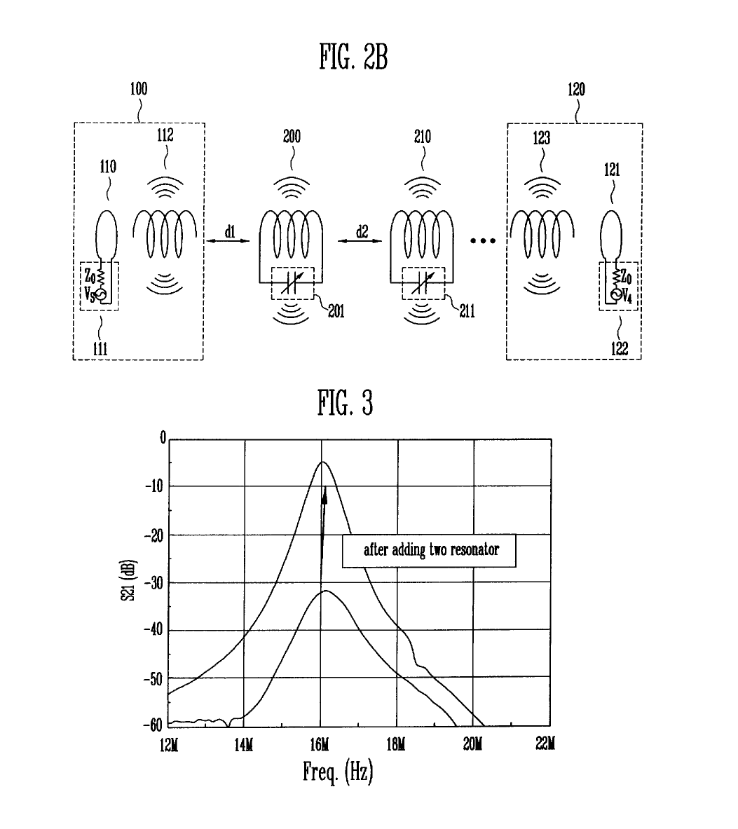

FIGS. 2A and 2B are diagrams of high-efficiency wireless power transmission systems according to first and second exemplary embodiments of the present invention. Referring to FIG. 2A, a high-efficiency wireless power transmission system according to the first exemplary embodiment of the present invention further includes a power-relaying resonant coil 200 that functions to relay power between the transmitting coil 112 and the receiving coil 123. The power-relaying resonant coil 200 has the unique resonant frequency, and resonates at the same frequency as the transmitting coil 112, thereby relaying a non-radiative electromagnetic wave.

A resonant frequency adjusting means, for example, a variable capacitor 201 is prepared in the power-relaying resonant coil 200 and can adjust the resonant frequency.

Referring to FIG. 2B, a high-efficiency wireless power transmission system according to the second exemplary embodiment of the present invention includes a plurality of power-relaying resonant coils 200 and 210 between a transmitting coil 112 and a receiving coil 123, thereby lengthening the transmission distance. Here, the unique resonant frequencies of the power-relaying resonant coils 200 and 210 may be the same as the unique resonant frequency of the transmitting coil 112. In other words, the transmitting coil 112 may resonate together with the power-relaying resonant coil 200, and the power-relaying resonant coil 200 may resonate together with the power-relaying resonant coil 210. Also, resonant frequency adjusting means 201 and 211 may be prepared in the power-relaying resonant coils 200 and 210, respectively. In this constitution, a non-radiative electromagnetic wave is transmitted from the transmitting coil 112 to the receiving coil 123 via the power-relaying resonant coils 200 and 210.

When the quality factor (Q) of a resonant coil is very high, a transmission distance can be theoretically lengthened infinitely. However, the distance is actually limited by power loss in the coil. Even if the transmission distance is lengthened using the power-relaying resonant coils 200 and 210, impedance matching should be taken into consideration. To be specific, a distance d1 and a distance d2 should be appropriately adjusted in consideration of impedance matching.

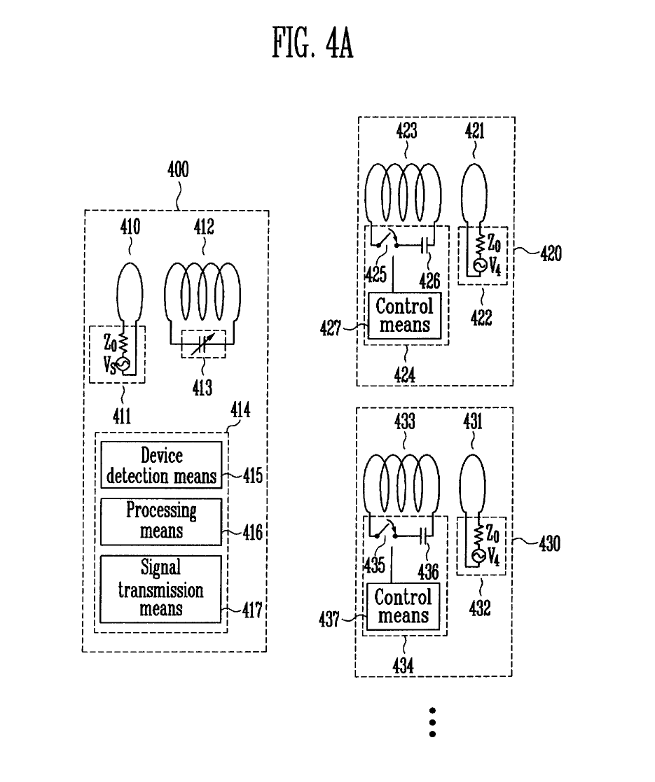

FIG. 3 is a graph showing power transmission efficiency over a long distance increased using two power-relaying resonant coils according to an exemplary embodiment of the present invention. As shown in FIG. 3, transmission efficiency obtained when power-relaying resonant coils are used is higher than that obtained when power-relaying resonant coils are not used.

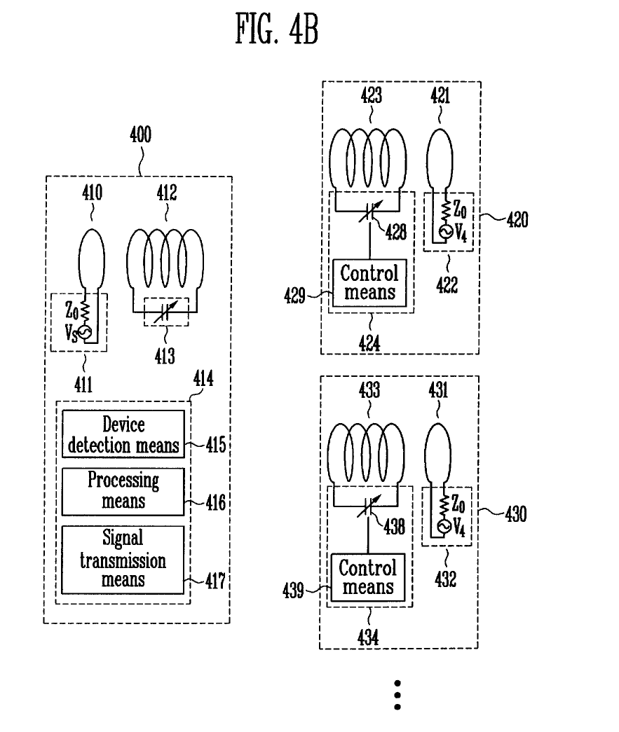

FIGS. 4A and 4B are diagrams of wireless power transmission systems for transmitting power to a plurality of devices according to first and second exemplary embodiments of the present invention.

FIG. 4A shows a structure of a wireless power transmission system for transmitting power to a plurality of devices according to the first exemplary embodiment of the present invention.

The wireless power transmission system according to the first exemplary embodiment of the present invention includes a power transmitter 400 having a power generation module 411 that generates power, a power coil 410 to which the generated power is applied, a transmitting coil 412 that resonates at the unique resonant frequency due to magnetic induction with the power coil 410, and generates a non-radiative electromagnetic wave, and a variable capacitor 413 that adjusts a resonant frequency of the transmitting coil 412. The power transmitter 400 includes a time-division power transmission control means 414 for transmitting power to one of a plurality of power receivers 420 and 430 at a specific time. The time-division power transmission control means 414 includes a device detection means 415 that detects a power receiving device to which power can be wirelessly transmitted, that is, the power receivers 420 and 430 and counts the number of power receivers receiving the power, a processing means 416 that determines time periods for which the respective power receivers 420 and 430 receive the power in a time division method according to the number of counted power receivers, and a signal transmission means 417 that transmits information about which one of the power receivers 420 and 430 receives power during a divided time period, more specifically, a signal causing a specific power receiver to receive the power during a time period assigned by the processing means 416 to the power receivers 420 and 430.

The wireless power transmission system includes the first power receiver 420 and the second power receiver 430. Although the first exemplary embodiment is illustrated to include two power receivers, the present invention is not limited to the first exemplary embodiment. The first power receiver 420 includes a receiving coil 423 that receives the generated non-radiative electromagnetic wave and resonates at the same frequency as the transmitting coil 412, a load coil 421 that receives energy stored in the receiving coil 423, and a power receiving module 422 that receives power received by the load coil 421. Also, the first power receiver 420 includes a resonant frequency adjusting means 424 that receives the signal transmitted by the signal transmission means 417 and controls the unique resonant frequency of the receiving coil 423.

The resonant frequency adjusting means 424 includes a switch 425, a capacitor 426, and a receiving coil control means 427. The coil control means 427 receives the signal transmitted by the signal transmission means 417, determines whether the receiving coil 423 should have the same unique resonant frequency as the transmitting coil 412, and adjusts the switch 425 according to the determination.

Likewise, the second power receiver 430 includes a receiving coil 433, a load coil 431, a power receiving module 432, and a resonant frequency adjusting means 434 that receives the signal transmitted by the signal transmission means 417 and controls the unique resonant frequency of the receiving coil 423. The resonant frequency adjusting means 434 includes a switch 435, a capacitor 436, and a receiving coil control means 437. These components have the same functions as the respective components of the first power receiver 420.

When there are two power receivers as shown in FIG. 4A, the device detection means 415 recognizes the first and second power receivers 420 and 430 and determines that the number of power receivers is two. The processing means 416 divides a time into as many periods as the number of power receivers, i.e., two periods in the time division method, and determines time periods for which the respective power receivers 420 and 430 receive power. For example, a specific time period T is divided into two time periods T1 and T2, and the first and second power receivers 420 and 430 are set to receive power during the time period T1 and the time period T2, respectively. The signal transmission means 417 transmits a signal identifying a power receiver to receive power according to each time period.

The receiving coil control means 427 and 437 included in the resonant frequency adjusting means 424 and 434 of the power receivers 420 and 430 receive the signal of the signal transmission means 417, check whether their power receivers should receive power, and control the switches 425 and 435. To be specific, when the receiving coil control means 427 receives a signal about a time period for which the first power receiver 420 receives power according to the time division method, for example, a signal indicating that power should be received, the receiving coil control means 427 controls the switch 425 to equalize the unique resonant frequency of the receiving coil 423 with that of the transmitting coil 412, so that the first power receiver 420 can receive power. At this time, the receiving coil control means 437 of the second power receiver 430 controls the switch 435 not to equalize the unique resonant frequency of the receiving coil 433 with that of the transmitting coil 412, so that the second power receiver 430 does not hinder the first power receiver 420 from receiving power.

In other words, the first exemplary embodiment of the present invention transmits power to respective devices in the time division method, and wirelessly designates which one of the devices receives the power. In this case, only one power receiver receives power during each time period. Thus, even if the number of power receivers increases, it is not required to know a change in impedance in advance.

FIG. 4B shows a structure of a wireless power transmission system for transmitting power to a plurality of devices according to the second exemplary embodiment of the present invention. The second exemplary embodiment of FIG. 4B has the same constitution as the first exemplary embodiment of FIG. 4A except that the resonant frequency adjusting means 424 and 434 include variable capacitors 428 and 438 and receiving coil control means 429 and 439 that receive the signal transmitted by the signal transmission means 417, determine whether the unique resonant frequencies of the receiving coils 423 and 433 should be the same as that of the transmitting coil 412, and adjust the variable capacitors 428 and 438. In other words, the receiving coil control means 429 and 439 of the second exemplary embodiment of FIG. 4B control the variable capacitors 428 and 438 to adjust the unique resonant frequencies of the receiving coils 423 and 433, while the receiving coil control means 427 and 437 of the first exemplary embodiment of FIG. 4A control the switches 425 and 435 to adjust the unique resonant frequencies of the receiving coils 423 and 433.

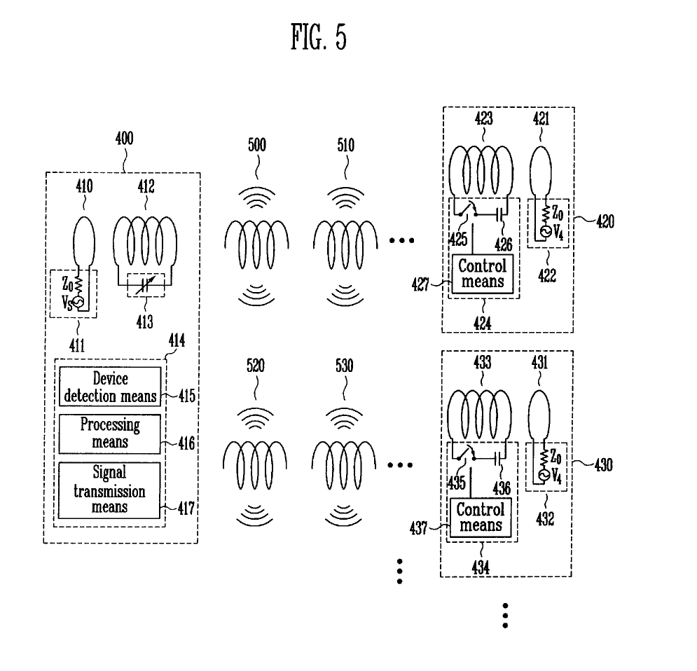

FIG. 5 is a diagram of a power transmission system according to another exemplary embodiment of the present invention that separately transmits power to several devices during divided time periods and increases power transmission efficiency using a power relay coil. The power transmission system according to this exemplary embodiment of the present invention includes a power transmitter 400, a plurality of power receivers 420 and 430, and a plurality of power relay coils 500, 510, 520 and 530. Via a plurality of relays, power is transmitted from the power transmitter 400 to one of the power receivers 420 and 430.

To transmit power to several devices, the time division method mentioned with reference to FIGS. 4A and 4B is used.

According to this exemplary embodiment of the present invention, it is possible to effectively and wirelessly transmit power to several devices in a predetermined area with high efficiency over a relatively long transmission distance.

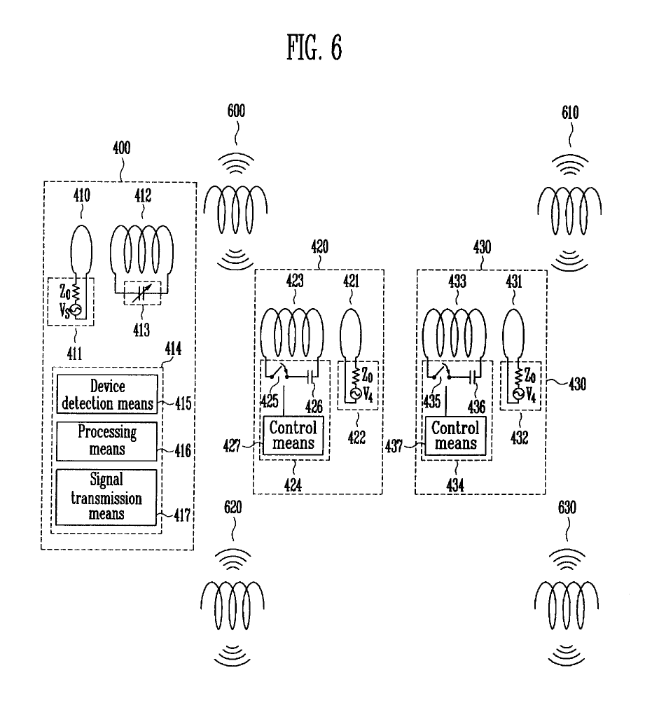

FIG. 6 is a diagram of a power transmission system according to yet another exemplary embodiment of the present invention that separately transmits power to several devices during divided time periods and forms a space in which power transmission can be efficiently performed using a power relay coil. The power transmission system according to this exemplary embodiment of the present invention includes a power transmitter 400, one or more power receivers 420 and 430, and a plurality of power relay coils 600, 610, 620 and 630. The power relay coils 600, 610, 620 and 630 are disposed at apexes or edges of a polygon, and form a space in which power can be wirelessly received inside the polygon. And, one or more power receivers 420 and 430 are disposed in the polygon to wirelessly receive power.

Alternatively, the power relay coils 600, 610, 620 and 630 may be disposed around a circle, and the power receivers 420 and 430 may be disposed inside the circle.

A magnetic resonance-based wireless power transmission system according to an exemplary embodiment of the present invention includes several power-relaying resonant coils for relaying power in addition to a conventional magnetic resonance-based wireless power transmission system. Also, a capacitor and switch capable of changing a resonant frequency are included in the receiving coil of each device, so that power can be separately transmitted to several devices according to time periods.

In the conventional system, transmission efficiency rapidly deteriorates as a transmission distance increases. This problem can be solved by disposing a resonant coil having the same resonant frequency as a transmitting coil between the transmitting coil and a receiving coil according to an exemplary embodiment of the present invention. In other words, the energy of a non-radiative electromagnetic wave generated by resonance of the transmitting coil is transferred through a relay coil having the same resonant frequency as the transmitting coil, and such a transfer may continue through several relay coils. Here, the position of the relay coil should be determined to achieve impedance matching for efficient transfer of electromagnetic energy.

When several devices are disposed in a conventional system, each of the devices is regarded as one load at a transmission frequency. Thus, impedance matching is broken, and transmission efficiency remarkably deteriorates. To solve this problem, an exemplary embodiment of the present invention changes the resonant frequency of a receiving coil according to divided time periods not to affect impedance matching in a transmission frequency band. To this end, a variable capacitor or switch may be included in the receiving coil.

Also, an exemplary embodiment of the present invention forms a specific area in which wireless power transmission is enabled by arranging relay coils, and simultaneously transmits power to several devices in the area.

A wireless power transmission system according to an exemplary embodiment of the present invention enables power transmission to electronic devices over a long distance and prevents unnecessary heat. Also, it is possible to simply lengthen a transmission distance by disposing a power relay coil, and to intentionally set an area in which wireless power transmission is enabled. Furthermore, using a time division system, it is possible to transmit power to several devices.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A wireless power transmission device, comprising:
a power generation module for generating power;
a power coil for receiving the power;
a transmitting coil for resonating at a unique resonant frequency due to magnetic induction with the power coil, and generating a non-radiative electromagnetic wave; and
one or more power relay coils for relaying the non-radiative electromagnetic wave.

2. The wireless power transmission device of claim 1, wherein the power relay coils resonate at the same frequency as the transmitting coil.

3. The wireless power transmission device of claim 2, wherein each of the power relay coils includes a resonant frequency adjusting means for adjusting a unique resonant frequency of the power relay coil.

4. The wireless power transmission device of claim 3, wherein the resonant frequency adjusting means includes a variable capacitor.

5. The wireless power transmission device of claim 1, wherein a power transmission distance increases as a number of the power relay coils increases.

6. The wireless power transmission device of claim 1, wherein the power relay coils are disposed at apexes or edges of a polygon and relay the non-radiative electromagnetic wave inside the polygon.

7. The wireless power transmission device of claim 1, wherein the power relay coils are disposed around a circle and relay the non-radiative electromagnetic wave inside the circle.

8. A wireless power transmission device, comprising:
a power generation module for generating power;
a power coil for receiving the power;
a transmitting coil for resonating at a unique resonant frequency due to magnetic induction with the power coil, and generating a non-radiative electromagnetic wave; and
a control means for detecting power receivers and transmitting a signal indicating which one of the power receivers receives the power at a specific time in a time division method to the power receivers.

9. The wireless power transmission device of claim 8, wherein the control means includes:
a device detection means for detecting the power receivers and counting a number of the power receivers;
a processing means for determining time periods for which the respective power receivers receive the power in the time division method according to the number of the power receivers; and
a signal transmission means for transmitting the signal indicating which one of the power receivers receives the power at a specific time to the power receivers.

10. The wireless power transmission device of claim 8, wherein the transmitting coil includes a resonant frequency adjusting means for adjusting the unique resonant frequency of the transmitting coil.

11. The wireless power transmission device of claim 10, wherein the resonant frequency adjusting means includes a variable capacitor.

12. A wireless power reception device, comprising:
a receiving coil for receiving a non-radiative electromagnetic wave generated by a transmitting coil, and resonating at the same frequency as the transmitting coil;
a load coil for receiving energy stored in the receiving coil; and
a power receiving module for receiving power received by the receiving coil,
wherein the receiving coil includes a resonant frequency adjusting means for adjusting a unique frequency of the receiving coil to receive the non-radiative electromagnetic wave and resonate during a divided time period only.

13. The wireless power reception device of claim 12, wherein the resonant frequency adjusting means includes a capacitor and a switch, and adjusts the switch to equalize the unique resonant frequency of the receiving coil with a unique resonant frequency of the transmitting coil during the divided time period only.

14. The wireless power reception device of claim 13, wherein the resonant frequency adjusting means includes a control means for receiving a signal having information on a time period for which the power is received in a time division method, and controlling the switch according to the signal.

15. The wireless power reception device of claim 12, wherein the resonant frequency adjusting means includes a variable capacitor, and adjusts a capacitance of the variable capacitor to equalize the unique resonant frequency of the receiving coil with a unique resonant frequency of the transmitting coil during the divided time period only.

16. The wireless power reception device of claim 15, wherein the resonant frequency adjusting means includes a control means for receiving a signal having information on a time period for which the power is received in a time division method, and adjusting the capacitance of the variable capacitor according to the signal.
